(19) United States
(12) Patent Application Publication
(10) Pub. No.: US 2018/0305500 A1
(43) Pub. Date: Oct. 25, 2018

(54) COMPOSITION CONTAINING LOW-VOC, AMINOALKYL-FUNCTIONAL SILICON COMPOUNDS FOR COATING COLORS FOR THE TREATMENT OF PAPER OR FILM

(71) Applicant: EVONIK DEGUSSA GMBH, Essen (DE)

(72) Inventors: Peter JENKNER, Wesel (DE); Christoph BATZ-SOHN, Hanau-Mittelbuchen (DE); Heinz LACH, Rodenbach (DE); Stefan SCHARFE, Erlensee (DE); Philipp ALBERT, Loerrach (DE); Eckhard JUST, Rheinfelden (DE)

(73) Assignee: EVONIK DEGUSSA GMBH, Essen (DE)

(21) Appl. No.: 16/016,571

(22) Filed: Jun. 23, 2018

Related U.S. Application Data
(62) Division of application No. 12/674,601, filed on Feb. 22, 2010.

(30) Foreign Application Priority Data
Aug. 28, 2007 (DE) 102007040802.3

(51) Int. Cl. C08G 77/54; C09D 183/14; C08L 83/14; B41M 5/52

(52) U.S. Cl. CPC C08G 77/54; C09D 183/14; B41M 5/529; B41M 5/52; B41M 5/5218; C08L 83/14

(57) ABSTRACT

A composition has particularly good solubility in water. The composition includes an aminoalkyl-functional and/or oligo-silylated-aminoalkyl-, hydroxy-, and optionally alkoxy-functional silicon compound having reacted units of (A) an aminoalkylalkoxysilane; (B) a bis-silylated alkylamine; (C) a tri-silylated alkylamine; and (D) at least two of the alkylamines (A), (B), and (C), where the free alcohol content of the composition is less than or equal to 1% by weight, based on the composition.

The present invention relates to the use of a low-VOC composition comprising aminoalkyl-functional silicon compounds for coating colors for the treatment of paper or film for inkjet applications, to a corresponding composition per se, and to its preparation, (VOC=volatile organic compounds)

Aminosilanes are known as water-soluble adhesion promoters, in the form, for example, of what are called sizing or primers in the glass fiber industry.

A series of further fields of application for amino-functional silanes and siloxanes are as follows:

Use in coating systems, in the field of corrosion protection, for the biocidal treatment of surfaces, in wood treatment, in the production of electrophotographic toners (EP 0 992 857 B1), in the paper industry (EP 1 559 750 A2, EP 1 408 155 A1, EP 1 413 451 B1), as an ingredient in a mine silicone fluids (U.S. Pat. No. 5,077,421), as an ingredient in epoxy resins [Chemical Abstracts (1991)—CA 114; 83579s], for the production of organically modified glasses (EP 0 223 987 A2), as anticancer agents [Chemical Abstracts (1983)—CA 99; 133650c], for modifying surfaces of glass and surfaces of glass fiber, in wastewater treatment, for pigment treatment, as an ingredient in catalysts and for their preparation (U.S. Pat. No. 4,053,534), as a flocculating agent in adhesives and sealants or cable applications, to name but a few examples.

It is known, furthermore, to use amino-functional, partially hydrolyzed alkoxysilane oligomers in order to reduce the agglomeration of inorganic powders. Hence it is indicated in U.S. Pat. No. 5,543,173 that such preparations also comprise considerable amounts of alcohol.

Cationic organosilane polycondensation products in alcoholic solution are known, for example, from U.S. Pat. No. 5,591,818. In the preparation of the hydrogen salts, exclusively mono-silylated alkylamines are employed.

Oligo-silylated alkylamines, such as bis(trialkoxysilylalkyl)amine or tris(3-triethoxysilylpropyl)amine, or mixtures thereof, are not infinitely soluble in water, even with addition of acid. Furthermore, such solutions are generally not stable for long. They tend to form gels or particles, a phenomenon which, at application, can lead to increased instances of nozzle clogging and hence to production stoppage and longer downtimes. Furthermore, significant amounts of hydrolysis alcohol are released.

WO 05/014741 discloses alcoholic aminosilane-containing or aminosiloxane-containing—i.e., VOC-rich—compositions and also their use for inks and paints, and also for treating fillers and pigments.

Furthermore, US 2000/0013971 A1 discloses, for materials for inkjet applications, composition comprising only aminosilicon compounds and alcohol, and also coating colors based thereon.

A feature common to these systems is they still contain a high fraction of volatile organic compounds (VOC), especially alcohols, which particularly in the production of inkjet specific papers leads to high environmental pollution, or necessitates the use of correspondingly costly and inconvenient technology in order to prevent such pollution, and also to ensure workplace protection for the individuals involved.

Moreover, purely water based compositions with polyfunctional organopolysiloxanes as adhesion promoters are known; cf., inter alia, EP 0 675 128 B1, EP 0 716 128 B1, and EP 1 101 787 A2. Polysiloxanes of this kind in general no longer carry any alkoxy groups; that is, they are in fully hydrolyzed form. EP 0 716 127 A2 as well discloses organopolysiloxane-containing compositions based on water, which are used, among other things, for the silanization of fillers, for the hydrophobicization of textiles, leather, cellulose products, and starch products, and also as additives to inks and paints. Although such systems are dilutable with water virtually ad infinitum, they are nevertheless sensitive in terms of their stability and their properties when further components are added, such as when polyvinyl alcohol (PVA) is added, for example, PVA being used for example in the production of coating colors for the coating of specialty paper for inkjet applications.

It was an object of the invention to provide a very low-VOC composition based on aminosilanes for the preparation of coaling colors. A particular concern was to use such coating colors to treat specialty paper or film for inkjet applications, without detracting from the properties.

The stated object is achieved in accordance with the invention as specified in the claims.

It has surprisingly been found that, in a simple and economic way, a composition which is low in volatile organic compounds (VOC) or is substantially VOC-free can be prepared and, advantageously, on account of its environmentally benign nature, can be used in coating colors, more particularly for the treatment of paper or film for inkjet applications, said composition being based at feast proportionally on one or more partially or fully hydrolyzed and optionally condensed or cocondensed aminoalkyl-functional and also oligo-silylated-aminoalkyl, alkoxy- and/or hydroxy-functional silicon compounds, and the alcohol is at least proportionally removed from the composition.

A composition of this kind for use in the sense of the present invention can advantageously be prepared by initially introducing or mixing the amino-functional, hydrolyzable silane ingredient or ingredients; optionally, furthermore, a solvent or diluent can be added, preferably the alcohol corresponding to the alkoxysilanes that are preferably employed; in addition, optionally, an organic or inorganic acid can be added, in which case, suitably, a degree of neutralization of the mono-silylated aminoalkyl groups and/or oligo-silylated aminoalkyl groups of 0% to 125%, preferably of 0.01% to 120%, more preferably 70% to 115%, very preferably 75% to 110%, is set; the alkoxysilanes preferably employed are deliberately partially or fully hydrolyzed by addition of a defined amount of water, in which case, in total, 0.01 to 1000 mol, preferably 0.1 to 500 mol, more preferably 0.2 to 250 mol, very preferably 0.3 to 100 mol, more particularly 0.5 to 10 mol of water are used per mole of Si of the silanes employed here; the hydrolysate is optionally condensed and also cocondensed, it being possible for corresponding organosiloxanes to form as condensates or cocondensates of the silicon compounds employed here; and the fraction of free alcohol present and/or highly volatile organic constituents is substantially removed from the system, preferably by distillation, more particularly by gentle heating and reduced pressure. The level of organic compounds which are readily volatile under ambient conditions (VOC), more particularly of alcohols such as methanol, ethanol or isopropanol, in the composition can in this operation be set to a level of less than or equal to 1% by weight, in particular of less than or equal to 0.5% by weight, i.e., down to the detection limit (water determination, for example, by Karl-Fischer method or by means of GC analysis), based on the composition. Where no acid is added in the reaction, or where the aim is to alter the degree of neutralization of amino groups present or to lower the pH in the present composition, or to subject the composition to further processing, said composition can also be admixed with acid following its preparation, as well. It is possible, however, to forego entirely the addition of acid to a composition that can be used in accordance with the invention. In this way a low-VOC, i.e., substantially VOC-free composition which can be used in accordance with the invention can be provided and can be used advantageously as a basis for a coating color, it being possible for a coating color of this kind, based on a composition of the invention, to be used outstandingly to treat paper or film, especially for inkjet applications.

The present invention accordingly provides for the use of a composition low in volatile organic compounds (VOC) or substantially VOC-free in coating colors, the composition being based at least proportionally on one or more partially or completely hydrolyzed and optionally condensed or cocondensed aminoalkyl-functional and also oligo-silylated-aminoalkyl-, and/or hydroxy-functional silicon compounds, and the alcohol being removed at least proportionally from the composition.

The present invention further provides a process for preparing a composition which can be used in accordance with the invention,

by subjecting

(A) at least one aminoalkylalkoxysilane of the general formula I

NR′₂[(CH₂)₂NR′]ₓ—Y—Si(R″)ₙ(OR)₃₋ₙ (I)
in which groups R, R′ and R″ are alike or different and are each a hydrogen atom or a linear or branched alkyl group having 1 to 8 C atoms, Y is a divalent alkylene group from the series —CH₂—, —(CH₂)₂—, —(CH₂)₃— or —[CH₂CH(CH₃)CH₂]—, x is 0, 1 or 2, and n is 0 or 1,
   or

(B) at least one bis-silylated alkylamine of the general formula II

(RO)₃₋ₘ(R″)ₘSi—Y—[NR′(CH₂)₂]_{y}NR′[(CH₂)₂NR′]₂—Y—Si(R″)ₙ(OR)₃₋ₙ (II),
in which groups R, R′ and R″ are alike or different and are each a hydrogen atom or a linear or branched alkyl group having 1 to 8 C atoms, groups Y are alike or different and Y is a divalent alkylene group from the series —CH₂—, —(CH₂)₂—, —(CH₂)₃— or —[CH₂CH(CH₃)CH₂]—, y and z independently are 0, 1 or 2, and m and n independently are 0 or 1,
   or

(C) at least one tris-silylated alkylamine of the general formula III

N[—Y—Si(R″)ₙ(OR)₃₋ₙ]₃ (III),
in which groups R and R″ are alike or different and are each a hydrogen atom or a linear or branched alkyl group having 1 to 8 C atoms, Y independently is a divalent alkylene group from the series —CH₂—, —(CH₂)₂—, —CH₂)₃— or —[CH₂CH(CH₃)CH₂]—, and n independently is 0 or 1,
   or

(D) at least two or the above-stated silylated alkylamines of the general formula I, II, and III
to hydrolysis and also condensation or cocondensation, using a defined amount of water, and optionally with addition of an acid, and
substantially removing the free alcohol from the system.

In the present patent application, references to mono-silylated amines are to include those of the formulae I. Oligo-silylated amines mean more particularly those which carry two and more than two silyl groups on an amino group or alkylamine, in accordance for example with formula II (bis-silylated) or formula III (tris-silylated), and/or corresponding compounds, which may also be in cyclized form.

In the preparation of a composition used in accordance with the invention it is preferred as aminoalkylalkoxysilanes of the general formula I to use

H₂N(CH₂)₃Si(OCH₃)₃ (AMMO),

H₂N(CH₂)₃Si(OC₂H₅)₃ (AMEO),

H₂N(CH₂)₂NH(CH₂)₃Si(OCH₃)₃ (DAMO),

H₂N(CH₂)₂NH(CH₂)₂NH(CH₂)₃Si(OCH₃)₃ (TRIAMO),

and also, if desired, so-called cyclic compounds corresponding thereto.

Preferred as compounds of formula II are

(H₃CO)₃Si(CH₂)₃NH(CH₂)₃Si(OCH₃)₃ (bis-AMMO),

(H₅C₂O)₃Si(CH₂)₃NH(CH₂)₃Si(OC₂H₅)₃ (bis-AMEO),

(H₃CO)₃Si(CH₂)₃NH(CH₂)₂NH(CH₂)₂NH(CH₂)₃Si(OCH₃)₃ (bis-DAMO),

(H₃CO)₃Si(CH₂)₃NH(CH₂)₂NH(CH₂)₂NH(CH₂)₂NH(CH₂)₂NH(CH₂)₃Si(OCH₃)₃ (bis-TRIAMO),

and also, as compounds of formula III,

N[CH₂)₃Si(OCH₃)₃]₃ (tris-AMMO)

N[CH₂)₃Si(OC₂H₅)₃]₃ (tris-AMEO).

Thus for the implementation of the process of the invention it is preferred to select at least one component (A) from the series AMMO, AMEO, DAMO, TRIAMO,

3-(N-alkylamino)propyltrialkoxysilane, where alkyl is methyl, ethyl, n-propyl or n-butyl and alkoxy is methoxy or ethoxy,

a preferred selection of component (B) may take place from the series bis-AMMO, bis-AMEO, bis-DAMO, bis-TRIAMO, and

component (C) from the series tris-AMMO, tris-AMEO.

Likewise it is possible with advantage in the process of the invention to use mixtures which comprise compounds of the general formulae I, II, and/or III. It is also possible for mixtures of this kind which can be used in accordance with the invention to comprise what are referred to as partial condensation products of said aminoalkoxysilanes. Partial condensation products or reaction products of aminoalkoxysilanes of the general formulae I, II and/or III are suitably those dimeric, trimeric, tetrameric or higher oligomeric products which in general are formed by condensation or cocondensation and/or prehydrolysis of the respective monomers, with elimination of alcohol. In corresponding condensates and cocondensates, therefore, the reactant components are linked via Si—O—Si bonds. It is known, furthermore, that a ring is opened on hydrolysis or alcoholysis, and the corresponding aminoalkylalkoxysilane or -silanol is obtained. It is also possible for compounds of the general formula II to be present in cyclic or bicyclic form and to be used as such in the process of the invention.

Likewise provided for by the present invention is a composition which can be used in accordance with the invention, wherein aminoalkyl-functional and/or oligo-silylated-aminoalkyl-, hydroxy-, and optionally alkoxy-functional silicon compounds comprising in the composition represent a reaction product from the reaction, i.e., the partial or complete hydrolysis and also, where appropriate, condensation or cocondensation, of

(A) at least one aminoalkylalkoxysilane of the general formula I

NR′₂[(CH₂)₂NR′]ₓ—Y—Si(R″)ₙ(OR)₃₋ₙ (I),
in which groups R, R′ and R″ are alike or different and are each a hydrogen atom or a linear or branched alkyl group having 1 to 8 C atoms, Y is a divalent alkylene group from the series —CH₂—, —(CH₂)₂—, —(CH₂)₃— or —[CH₂CH(CH₃)CH₂]—, x is 0, 1 or 2, and n is 0 or 1,
   or

(B) at least one bis-silylated alkylamine of the general formula II

(RO)₃₋ₘ(R″)ₘSi—Y—[NR′(CH₂)₂]_{y}NR′[(CH₂)₂NR′]ₓ—Y—Si(R″)ₙ(OR)₃₋ₙ (II),
in which groups R, R′ and R″ are alike or different and are each a hydrogen atom or a linear or branched alkyl group having 1 to 8 C atoms, groups Y are alike or different and Y is a divalent alkylene group from the series —CH₂—, —(CH₂)₂—, —(CH₂)₃— or —[CH₂CH(CH₃)CH₂]—, y and z independently are 0, 1 or 2, and m and n independently are 0 or 1,
   or

(C) at least one tris-silylated alkylamine of the general formula III

N[—Y—Si(R″)ₙ(OR)₃₋ₙ]₃ (III),
in which groups R and R″ are alike or different and are each a hydrogen atom or a linear or branched alkyl group having 1 to 0 C atoms, Y independently is a divalent alkylene group from the series —CH₂—, —(CH₂)₂—, —(CH₂)₃— or —[CH₂CH(CH₃)CH₂]—, and n independently is 0 or 1,
   or

(D) at least two of the above-stated silylated alkylamines of the general formula I, II, and III

and
the free alcohol content of the composition is less than or equal to 1% by weight, preferably less than or equal to 0.5% by weight, based on the composition.

According to chemical understanding the reaction produces essentially a mixture of amino-group-containing alkoxy-/hydroxy-silanes and/or silanols and also condensation products and cocondensation products based thereon (corresponding to linear, branched, cyclic, and, possibly, three-dimensionally crosslinked siloxanes) starting from compounds of the general formulae I, II or III and/or corresponding partial condensation products. Particularly preferred, however, are compositions in which there are corresponding amino-functional silicon compounds which are in each case fully hydrolyzed, i.e., carry substantially no alkoxy groups any more, so that hydrolysis alcohol can is released in the presence of water.

In the preparation of a composition used in accordance with the invention, the reaction, more particularly hydrolysis and also condensation or cocondensation, is preferably conducted at a temperature <100° C., preferably from 10 to 80° C., more preferably from 15 to 60° C., more particularly from 20 to 50° C.

Optionally it is possible here to use an organic or inorganic acid. Hence use may be made advantageously of hydrochloric acid (HCl or aqueous hydrochloric acid) or aqueous acetic acid or aqueous formic acid, the fraction of water introduced as a result being at the same time added to the count of the amount of water to be introduced in accordance with the invention for the deliberate hydrolysis of the alkoxysilanes. Alternatively the addition of acid may be made subsequent to the preparation of the present composition, in which case, preferably, a pH of 2 to 6, more particularly of 3 to 5, is set.

In the process of the invention there is in particular a distillative workup of the product mixture from the reaction; in other words, from the product mixture obtained, the constituents that are otherwise highly volatile under ambient conditions, more particularly the hydrolysis alcohol, and also any solvent or diluent added, is distilled off at least proportionally, preferably with gentle heating and under reduced pressure. Where appropriate, the amount of volatile constituents removed from the system can be replaced by an equal volume of water and/or acid.

Thus a composition of the invention may preferably contain organic or inorganic acid, in which case, suitably, a degree of neutralization of the aminoalkyl groups and oligo-silylated aminoalkyl groups of 0% to 125%, preferably 0.1% to 120%, more preferably 70% to 115%, very preferably 75% to 110%, based on the amine number, is present. The amine number can be determined in general by DIN 32 625 (potentiographic titration with HCl).

The acid used is preferably an inorganic or organic acid, more particularly hydrochloric acid, acetic acid or formic acid, and, according to chemical understanding, the aminoalkyl-functional and oligo-silylated-aminoalkyl-functional silicon compounds in the present composition are present at least proportionally in the form of a cationic amine mixture; in other words, a composition used in accordance with the invention preferably contains acid and/or a corresponding salt of acid and one of the amino-functional compounds present.

The pH of a composition used in accordance with the invention is preferably in the range from 2 to 11 more preferably between 2.5 and 6.5, very preferably in the range from 3.0 to 6.0, more particularly between 3.5 and 5.0.

Compositions of the invention are generally characterized, furthermore, by a viscosity of 2 to 1000 mPa s, preferably 3 to 500 mPa s, more preferably of 4 to 250 mPa s, the viscosity being determinable in accordance, for example, with DIN 53 015.

More particularly the compositions which can be used in accordance with the invention are notable for particularly good solubility in water.

In the sense of the present invention it is preferred to use a composition, wherein at least one silicon compound of the aminoalkyl-functional and/or oligo-silylated-aminoalkyl-, hydroxy-, and optionally alkoxy-functional silicon compounds present in the composition represent a reaction product from the reaction, i.e., the partial or complete hydrolysis and also, where appropriate, condensation or cocondensation, of

(A) at least one aminoalkylalkoxysilane of the general formula I

NR′₂[(CH₂)₂NR′]ₓ—Y—Si(R″)ₙ(OR)₃₋ₙ (I),
in which groups R, R′ and R″ are alike or different and are each a hydrogen atom or a linear or branched alkyl group having 1 to 8 C atoms, Y is a divalent alkylene group from the series —CH₂—, —(CH₂)₂—, —(CH₂)₃— or —[CH₂CH(CH₃)CH₂]—, x is 0, 1 or 2, and n is 0 or 1,
   or

(B) at least one bis-silylated alkylamine of the general formula II

(RO)₃₋ₘ(R″)ₘSi—Y—[NR′(CH₂)₂]_{y}NR′[(CH₂)₂NR′]_{z}—Y—Si(R″)ₙ(OR)₃₋ₙ (II),
in which groups R, R′ and R″ are alike or different and are each a hydrogen atom or a linear or branched alkyl group having 1 to 8 C atoms, groups Y are alike or different and Y is a divalent alkylene group from the series —CH₂—, —(CH₂)₂—, —(CH₂)₃— or —[CH₂CH(CH₃)CH₂]—, y and z independently are 0, 1 or 2, and m and n independently are 0 or 1,
   or

(C) at least one tris-silylated alkylamine of the general formula III

N[—Y—Si(R″)ₙ(OR)₃₋ₙ]₃ (III),
in which groups R and R″ are alike or different and are each a hydrogen atom or a linear or branched alkyl group having 1 to 8 C atoms, Y independently is a divalent alkylene group from the series —CH₂—, —(CH₂)₂—, —(CH₂)₃— or —[CH₂CH(CH₃)CH₂]—, and n independently is 0 or 1,
   or

(D) at least two of the above-stated silylated alkylamines of the general formula I, II, and III.

Thus, in the sense of the present invention, preference is given to a composition which contains from 0.1% to 99.5% by weight, based on the composition, of at least one at least partially hydrolyzed silicon compound.

Hence compositions which can be used in accordance with the invention have more particularly an active compound content in terms of cationic amino-functional silicon compounds and/or said reaction products of 0.1% to 95% by weight, preferably 1% to 80% by weight, more preferably 5% to 60% by weight, very preferably 10% to 50% by weight, based on the composition.

The composition used in accordance with the invention may have a water content of 99.9% to 0.5% by weight, based on the composition, with all of the constituents in the composition totaling 100% by weight.

A composition of the invention advantageously represents the bases for a coating color, which in general comprises further components, such as binders, e.g., polyvinyl alcohol (PVA), starch, gelatin, acrylate latices, etc., preferably nanoscale metal oxides, such as fumed silica, finely ground precipitated silica, crosslinkers, e.g., boric acid, glyoxal compounds, optical brighteners, process assistants, such as defoamers, surface-active substances, to name but a few.

Thus it is preferred to use a coating color which comprises at least one metal oxide, preferably fumed silica, which has an average particle size of less than 1 μm, more particularly from 50 to 400 nm, more preferably from 90 to 200 nm (median value, determination, for example, by static light scattering) and is in an amount of 5% to 50% by weight, more particularly of 10% to 30% by weight, based on the composition.

Furthermore, a coating color which is used in the sense of the present invention advantageously comprises at least partially hydrolyzed amino-functional silicon compounds in an amount of 1% to 10% by weight, preferably of 2% to 7% by weight, more preferably of 4% to 8% by weight, based on the coating pigment (metal oxide) used in the coating color.

It is preferred to use the present coating slip for the coating of paper or film, the coating color being applied advantageously to the surface of a film or paper, more particularly of a polyethylene (PE)-modified specialty paper, and dried and/or cured.

Thus a paper or a film obtainable using a composition of the invention or a said coating color can be used in a particularly environment-friendly way for inkjet applications and/or as photographic paper or as film for photographic prints.

In general the present invention may be performed as follows:

To prepare a said composition it is possible first of all to introduce at least one of said aminosilanes as per (A), (B) or (C), to carry out mixing, where appropriate with addition of alcohol and/or acid, to add water deliberately, and, under temperature monitoring and further commixing, to subject the alkoxysilanes present to at least partial hydrolysis and/or condensation or cocondensation. Subsequently, advantageously, VOC fractions, more particularly alcohol, are removed by distillation from a composition to be used in accordance with the invention.

An alternative possibility is to introduce a defined amount of water, which if appropriate has been acidified and may comprise alcohol, and to mix in the desired aminosilane or aminosilane mixture under temperature monitoring and with thorough commixing. Following the reaction it is preferred to distill off at least a fraction of the readily volatile constituents, more particularly alcohol, and it is possible—where necessary—to adapt the pH by addition of acid.

The preparation of a said composition may take place in general under inert gas blanketing.

A composition obtained in this way may advantageously form the basis for the preparation of a metal oxide dispersion, more particularly a dispersion of fumed silica. For this purpose the composition may be added in stages to a dispersion of the metal oxide, a dispersion of fumed silica for example, with care taken appropriately to ensure that the pH remains preferably at about 3 to 6, more particularly at around a pH of 4. This can be done by adding mineral acids, such as HCl, or else organic acids, such as acetic acid or formic acid. Subsequently the preparation is reacted with stirring at elevated temperature and also, where appropriate, with assistance from ultrasound. The dispersion can be subsequently filtered in order to remove unwanted coarse fractions.

The dispersion thus obtained may be used advantageously as a basis for the preparation of a coating color. For that purpose the dispersion may be added with stirring to a solution of the binder, e.g., PVA, and also further coating color additives, such as crosslinkers, e.g., boric acid, glyoxal compounds, optical brighteners, process assistants, such as defoamers, surface-active substances, to name but a few.

The coating color can foe applied with the aid of known coating technologies, such as doctor blades, contact coating, e.g., blade coating, and also noncontact casting technologies, e.g., slide coating, curtain coating, to paper or film, and dried correspondingly. In this way it is possible, preferably with an optimized ratio of binder to coating pigment, to produce a microporous coating which is capable of absorbing ink drops at high speed. The surface of the coating pigments, which is positively charged as a result of the aminosilane component, is able to produce particularly effective binding of the negatively charged ink dyes or ink pigments, and so leads to water-resistant prints.

Accordingly, in application and use of correspondingly treated paper in inkjet applications, compositions used in accordance with the invention are notable outstandingly for excellent adhesion and for high environmental compatibility. Thus the fraction of alcohol released in inkjet applications can be further significantly and hence advantageously reduced.

The present invention is illustrated by the examples below, without restriction of the subject matter.

### EXAMPLES

| Technical data | Determination method according to |
|---|---|
| Density | DIN 51 757 |
| Viscosity | DIN 53 015 |
| Color number | ISO 4630 |
| pH | DIN 19 268 (20° C., 1000 g/l) |
| Flash point | EN 22 719 |

The determination methods used to evaluate the present examples were in particular as follows:

Determination of Free Alcohol Content:

The alcohol determination was carried out by means of GC.

Column: RTX 200 (60 m)

Temperature program: 80-10-25-240-0

Detector: FID

Injection volume: 1.0 μl

Internal standard: 2-Butanol

Dry Residue

The solids content of the aqueous silane systems is determined as follows:

1 g of the sample is weighed out into a small porcelain dish and dried to constant weight in a drying cabinet at 105° C.

SiO₂ Content:

1.0 to 5.0 g of the sample in a 400 ml glass beaker is admixed with a Kjeldahl tablet and 20 ml of sulfuric acid, and the mixture is first slowly heated. The glass beaker is covered with a watch glass. The temperature is raised until the sulfuric acid fumes significantly and all of the organic constituents have been destroyed, the solution remaining clear and bright. The cold digestion solution is diluted to about 200 ml with distilled water and briefly boiled (water at the edge of the glass beaker allowed to flow under the acid). The residue is filtered through a white-ribbon filter and washed with hot water until the washing water indicates a pH of >4 (pH paper). The filter is dried in a platinum crucible, incinerated and calcined in a muffle furnace at 800° C. for 1 hour. After weighing, the residue is fumed off with hydrofluoric acid, the crucible is calcined by means of a fan burner, and calcined again if necessary at 800° C., and, after it has cooled, is weighed. The difference between the two weighings corresponds to the SiO₂ content.

Evaluation: D×100/E=% by weight SiO2

D=Weight difference before and after hydrofluoric acid removal of silicon as volatile silicon tetrafluoride, in mg

100=Conversion to %

E=Initial mass in mg

Methanol After Hydrolysis:

About 5 g of sample are weighed accurately into a 500 ml conical flask with ground-glass joints, and are hydrolyzed with 25 ml of sulfuric acid (w=20%) with shaking until a clear solution has formed.

Following addition of 75 ml of water, the sample is neutralized with aqueous sodium hydroxide solution (w=20%) and subjected to steam distillation in a suitable apparatus. The distillate is collected in a 250 ml measuring flask. Following addition of 2-butanol as internal standard, the sample is made up to the mark with distilled water.

The alcohol determination is made by means of GC.

Column: RTX 200 (60 m)

Temperature program: 90-10-25-240-0

Detector: FID

Injection volume: 1.0 μl

Internal standard: 2-Butanol

### Example 1

### Composition With Reduced VOC Content

A stirred apparatus with metering means and reflux condenser was charged under a nitrogen atmosphere with 470.6 g of Dynasylan® 1189 [N-(n-butyl)-3-aminopropyltrimethoxysilane, manufacturer: Degussa GmbH] and 80.0 g of methanol. Subsequently, via a metering means, a mixture consisting of 28.8 g of H₂O and 28.8 g of methanol was metered in over the course of 10 minutes (molar hydrolysis ratio Si:H₂O=1:0.8). During this addition the temperature rose from 28° C. to 50° C. The mixture was stirred at 60° C. for 3 h. Thereafter 208.89 g of methanol were distilled off at about 200 mbar. The final weight of the residue/product was 394.87 g.

A clear, slightly yellowish liquid was obtained which is stable on storage.

SiO₂ content: 29.6% (mass)

Methanol (after hydrolysis): 19.5% (mass)

Viscosity (20° C.): 26 mPa s

Density (20° C.): 0.996 g/cm³

### Example 2

### Composition With Reduced VOC Content

A stirred apparatus with metering means and reflux condenser was charged under a nitrogen atmosphere with 470.6 g of Dynasylan® 1189 and 80.0 g of methanol. Subsequently, via the metering means, a mixture consisting of 43.20 g of H₂O and 43.20 g of methanol was metered in over the course of 10 minutes (molar hydrolysis ratio Si:H₂O=1:1.2). During this addition the temperature rose from 28° C. to 56° C.

The mixture was stirred at 60° C. for 3 h. Thereafter 263.50 g of methanol were distilled off at about 200 mbar. The final weight of the residue/product was 367.77 g.

A clear, viscose, slightly yellowish liquid was obtained which is stable on storage.

SiO₂ content: 32.0% (mass)

Methanol (after hydrolysis): 9.2% (mass)

Viscosity (20°C.); 187 mPa s

Density (20° C.): 1.027 g/cm³

### Example 3

### A Substantially VOC-free Composition

A stirred apparatus with metering means and reflux condenser was charged under a nitrogen atmosphere with 498.2 g of water and 55.0 g of formic acid (conc. HCOOH=85%). Subsequently, using the metering means, 235.7 g of Dynasylan® 1189 were metered in. The pH was 4.8. The mixture was stirred at 60° C. for 3 h. Thereafter, at about 130-200 mbar, a methanol/water mixture was distilled off. The final weight of the residue was 589.0 g.

A clear, slightly yellowish liquid was obtained which has a pH of 5.3 and is stable on storage.

SiO₂ content: 9.2% (mass)

Flash point: >100° C.

Free methanol: 0.5% (mass)

Viscosity (20° C.): 11 mPa s

Density (20° C.): 1.070 g/cm³

Dry residue 105° C.: 36.2% (mass)

### Comparative Example 1

### Dispersion with Dynasylan® 1189 Incl. Methanol

### N-Butylaminopropyltrimethoxysilane, (C₇H₁₆N)Si(OCH₃)₃, 235 g/mol, Methanol Releasable By Hydrolysis: 48.5%

Apparatus:

Rotor-stator systems (Ultra-Turrax)

Jacketed pot, 3 liters

Dissolver for stirred incorporation of AEROSIL® 200

Polytron (rotor-stator) dispersing apparatus

Stirrer, 2 dropping funnels for dropwise addition of the silane solution and of the HCl solution

Heatable ultrasound bath (40 W ultrasound power)

500 μm sieve

1600 g of Dl water were introduced, and 400 g of AEROSIL® 200 were incorporated by stirring with the dissolver; acidification to a pH of 2.1 was carried out with 5 g of 18% strength HCl, and the batch was dispersed at 10,000 rpm for 15 min, using the Polytron. The solids content was found to be 20.07%.

Dissolver again at 2000 rpm, dropwise addition therein of 98.6 g of Dynasylan® 1189 in the form of a 20% strength solution in methanol, simultaneously with the maintenance of the pH of between pH 3-4 by dropwise addition of 18% strength HCl (total of 13 g, dispersion gels at pH>4). A further 15-min reaction time at 2000 rpm, followed by 60 min in the ultrasound bath at 80° C. (with lid), cooling and filtration via a 500 μm sieve.

Methanol content of the dispersion: 88.4 g=4.2%

The viscosity of the dispersions thus prepared was measured with a Brookfield viscometer after 24 h.

### Example 4

### Dispersion With the Composition From Example 3

Procedure analogous to that of comparative example 1, with the difference that 41.3 g of the composition from example 3 were used as a 40% strength solution in water, pH 4.1, VPS Hydrosil 2930, as silane component. Additionally 8 g of HCl were used.

Methanol content of the dispersion: no methanol detected

### Comparative Example 2

### Dispersion with Dynasylan® Hydrosil 2627 (Substantially Free From Alcohol, cf. EP 0 716 127 A2)

Analogous to comparative example 1, with the difference that 94 g of Dynasylan® Hydrosil 2627 (diluted to 20% strength solution in water) are used as silane component, 13 g of HCl are required.

### Example 5

### Dispersion With “1189 Oligomer” From Example 1

Partially hydrolyzed VPS “1189 oligomeric”, (C₇H₁₆N)SiO_{0.8}(OCH₃)_{1.4}, 203.4 g/mol, methanol releasable by hydrolysis 26.1%

Analogous to comparative example 1, with the difference that 85.3 g of oligomer (20% strength solution in water, pH 4.0) were used as silane component. 7 g of HCl were used.

Methanol content of the dispersion: 4.45 g=0.2%

### Example 6

### Dispersion With “1189 Oligomer” From Example 2

Partially hydrolyzed VPS “1189 oligomeric”, (C₇H₁₆N)SiO_{1.2}(OCH₃)_{0.4}, 183.4 g/mol, methanol releasable by hydrolysis 8.3%

Analogous to comparative example 1, with the difference that 77.0 g of oligomer (20% strength solution in water, pH 4.2) were used as silane component, 7.5 g of HCl were used.

Methanol content of the dispersion: 1.28 g=0.06%

TABLE 1
Data of the modified silica dispersions from comparative examples 1 and 2 and also examples 1 to 3; cf. examples 4 to 6

| | Dispersion 1 with | Dispersion 2 with | Dispersion 3 with | Dispersion 4 with | Dispersion 5 with |
|---|---|---|---|---|---|
| | composition from | composition from | composition from | composition from | composition from |
| | comparative example 1: | example 3: | comparative example 2: | example 1: | example 2: |
| | 4.25% MeOH | VOC-free | VOC-free | 0.2% MeOH | 0.06% MeOH |
| pH | 2.4 | 3.3 | 2.1 | 3.0 | 3.0 |
| Solids content w | 0.21 | 0.23 | 0.20 | 0.22 | 0.23 |
| 20 rpm; Sp. 2 | 104 mPa s | 132 mPa s | 84 mPa s | 160 mPa s | 184 mPa s |
| 50 rpm; Sp. 2 | 88 mPa s | 116 mPa s | 88 mPa s | 164 mPa s | 188 mPa s |
| 100 rpm; Sp. 2 | 120 mPa s | 124 mPa s | 96 mPa s | 160 mPa s | 172 mPa s |

rpm = Revolutions per minute of the Brookfield viscometer

### Application Example

### Preparation of Art Inkjet Coating Color

Inkjet coating colors were produced from the aqueous dispersions: cf. table 1.

The dispersions from the examples and comparative example were mixed on a dissolver at 500 rpm with a 13% strength solution of polyvinyl alcohol (solid, abbreviation PVA) Mowiol 40-88 from Clariant over the course of 10 minutes. The ratio on combining was calculated so as to give a dispersion C with a strength of 18 percent—based on the solid (pyrogenic oxide+PVA), in a ratio of 4:1 (100:25 Aerosil® to PVA, and addition of water if appropriate). The viscosity of this dispersion C, the inkjet coating color, was measured by means of a Brookfield viscometer after 24 h.

TABLE 2
Viscosity of the coating colors measured after 24 h:

| | Coating color 1 | Coating color 2 | Coating color 3 | Coating color 4 | Coating color 5 |
|---|---|---|---|---|---|
| | from dispersion 1 | from dispersion 2 | from disperison 3 | from dispersion 4 | from dispersion 5 |
| | (“4.25% MeOH”) | (“VOC-free”) | (“VOC-free”) | (“0.2% MeOH”) | (“0.6% MeOH”) |
| Solids content of the | 17.45 | 18.64 | Not | 18.21 | 17.93 |
| coating color (pyrogenic | | | possible | | |
| oxide with silane + PVA) | | | to produce! | | |
| % by weight | | | | | |
| Viscosity [mPa s] | 480 | 360 | n.a. | 430 | 330 |
| at 100 rpm and 50° C. | | | | | |

These coating colors were applied by means of a profiled bar coater to a photographic base paper (thickness 300 micrometers). The wet film thickness of the coating color was 110 micrometers. The coating was dried at 105° C. for 8 minutes.

The papers with the applied coating were printed on an Epson Stylus Photo R240 at maximum resolution.

TABLE 3
Evaluation of the print outcome:

| | Coating 1 from | | Coating 2 from | | Coating 3 from | | Coating 4 from | |
|---|---|---|---|---|---|---|---|---|
| Property | coating color 1 | | coating color 2 | | coating color 4 | | coating color 5 | |
| evaluated | Evaluation | Rating | Evaluation | Rating | Evaluation | Ratin | Evaluation | Note |
| Color intensity | Good | 2 | Good | 2 | Good | 2 | Good | 2 |
| Resolution | Good | 2 | Good | 2 | Good | 2 | Good | 2 |
| Ink run | No | 1 | No | 1 | No | 1 | No | 1 |
| (bleeding) | bleeding | | bleeding | | bleeding | | bleeding | |
| Color shift | Good | 2 | Good | 1.5 | Good- | 1.5 | Good- | 1.75 |
| | | | | | very good | | very good | |
| Average | Good | 1.75 | Good | 1.625 | Good | 1.625 | Good | 1.688 |

Best rating 1,
poorest rating 6

In the total of all of the properties of the coatings, all the coatings exhibited approximately the exact same values.

The viscosities of the coating colors produced with the various dispersions were substantially comparable. Here there was no apparent disadvantage from the reduction in methanol.

With the composition and dispersion/coating color of the invention it is therefore possible to provide a coating which, despite a significant reduction in the VOC fraction, produces an equally good print with an inkjet printer.

1-14. (canceled)

15. A composition, comprising:
an aminoalkyl-functional and/or oligo-silylated-aminoalkyl-, hydroxy-, and optionally alkoxy-functional silicon compound comprising reacted units of:
(A) at least one aminoalkylalkoxysilane of formula I
NR′₂[(CH₂)₂NR′]ₓ—Y—Si(R″)ₙ(OR)₃₋ₙ (I),
in which groups R, R′ and R″ are alike or different and are each a hydrogen atom or a linear or branched alkyl group having 1 to 8 C atoms, Y is a divalent alkylene group selected from the group consisting of —CH₂—, —(CH₂)₂—, —(CH₂)₃—, and
—[CH₂CH(CH₃)CH₂]—, x is 0, 1 or 2, and n is 0 or 1,
or
(B) at least one bis-silylated alkylamine of formula II
(RO)₃₋ₘ(R″)ₘSi—Y—[NR′(CH₂)₂]_{y}NR′[(CH₂)₂NR′]₂—Y—Si(R″)ₙ(OR)₃₋ₙ (II),
in which groups R, R′ and R″ are alike or different and are each a hydrogen atom or a linear or branched alkyl group having 1 to 8 C atoms, groups Y are alike or different and Y is a divalent alkylene group selected from the group consisting of —CH₂—, —(CH₂)₂—, —(CH₂)₃—, and —[CH₂CH(CH₃)CH₂]—, y and z independently are 0, 1 or 2, and m and n independently are 0 or 1,
or
(C) at least one tris-silylated alkylamine of formula III
N[—Y—Si(R″)ₙ(OR)₃₋ₙ]₃ (III),
in which groups R and R″ are alike or different and are each a hydrogen atom or a linear or branched alkyl group having 1 to 8 C atoms, Y independently is a divalent alkylene group selected from the group consisting of —CH₂—, —(CH₂)₂—, —(CH₂)₃—, and —[CH₂CH(CH₃)CH₂]—, and n independently is 0 or 1,
or
(D) at least two of the alkylamines of formula I, II, and III,
wherein
the free alcohol content of the composition is less than or equal to 1% by weight, based on the composition, and
wherein the reacted units are formed by partial or complete hydrolysis and also, where appropriate, condensation or cocondensation of compounds of (A), (B), (C), or (D).

16. A process for preparing the composition as claimed in claim 15, the process comprising:
at least partially hydrolyzing and, where appropriate, condensing or cocondensing:
(A) at least one aminoalkylalkoxysilane of formula I
NR′₂[(CH₂)₂NR′]ₓ—Y—Si(R″)ₙ(OR)₃₋ₙ (I),
in which groups R, R′ and R″ are alike or different and are each a hydrogen atom or a linear or branched alkyl group having 1 to 8 C atoms, Y is a divalent alkylene group selected from the group consisting of —CH₂—, —(CH₂)₂—, —(CH₂)₃—, and —[CH₂CH(CH₃)CH₂]—, x is 0, 1 or 2, and n is 0 or 1,
or
(B) at least one bis-silylated alkylamine of formula II
(RO)₃₋ₘ(R″)ₘSi—Y—[NR′(CH₂)₂]_{y}NR′[(CH₂)₂NR′]₂—Y—Si(R″)ₙ(OR)₃₋ₙ (II),
in which groups R, R′ and R″ are alike or different and are ach a hydrogen atom or a linear or branched alkyl group having 1 to 8 C atoms, groups Y are alike or different and Y is a divalent alkylene group selected from the group consisting of
—CH₂—, —(CH₂)₂—, —(CH₂)₃—, and —[CH₂CH(CH₃)CH₂]—, y and z independently are 0, 1 or 2, and m and n independently are 0 or 1,
or
(C) at least one tris-silylated alkylamine of formula III
N[—Y—Si(R″)ₙ(OR)₃₋ₙ]₃ (III),
in which groups R and R″ are alike or different and are each a hydrogen atom or a linear or branched alkyl group having 1 to 8 C atoms, Y independently is a divalent alkylene group selected from the group consisting of —CH₂—, —(CH₂)₂—, —(CH₂)₃—, and —[CH₂CH(CH₃)CH₂]—, and n independently is 0 or 1,
or
(D) at least two of the alkylamines of formula I, II, and III,
in the presence of water and optionally in the presence of an acid to obtain the silicon compound, and
substantially removing the free alcohol from the composition.

17. The process according to claim 16, wherein
said at least partially hydrolyzlng and, where appropriate, condensing or cocondensing is carried cut at a temperature of less than 100° C.

18. The process according to claim 16, wherein
said at least partially hydrolyzing and, where appropriate, condensing or cocondensing is carried out at a temperature of from 10° C. to 80° C.

19. The process according to claim 16, which further comprises
mixing the composition and applying ultrasound to the composition while mixing.

20. The process according to claim 16, wherein
the acid is present and is at least one member selected from the group consisting of hydrochloric acid, aqueous acetic acid, and aqueous formic acid.

21. The process according to claim 16, wherein said at least partially hydrolyzing and, where appropriate, condensing or cocondensing, is carried out in the presence of an inert gas.

22. The composition according to claim 15, wherein the composition further comprises at least one of an organic and an inorganic acid,
wherein the silicon compound comprises aminoalkyl groups and oligo-silylated aminoalkyl groups, and
wherein the silicon compound has a degree of neutralization of aminoalkyl groups and oligo-silylated aminoalkyl groups of from 0% to 125%, based on the amine number of the silicon compound, the amine number determined according to DIN 32 625.

23. The composition according to claim 15, wherein
the free alcohol content of the composition is less than or equal to 0.5% by weight, based on the composition.

24. The composition according to claim 15, wherein a PH of a composition is from 2 to 11.

25. The composition according to claim 15, wherein a pH of a composition is from 3.5 to 5.0.

26. The composition according to claim 15, which has a viscosity of from 2 to 1,000 mPa·s, determined according to standard DIN 53 015.

27. The composition according to claim 15, which comprises wafer, present in an amount of from 99.9% to 0.5% by weight, based on the total of the composition with all components of the composition totally 100% by weight.

28. The composition according to claim 15, which further comprises at least one member selected from the group consisting of a polyvinyl alcohol, starch, gelatin, an acrylate lattice, a nanoscale metal oxide, a crosslinker, a glyoxal compound, an optical brightener, and a process assistant.

29. The composition according to claim 15, which further comprises fumed silica,
wherein said fumed silica has an average particle size, determined by static light scattering, of less than 1 micron, and
wherein said fumed silica is present in the composition in an amount of from 5% to 50% by weight, based on the composition.

30. The composition according to claim 15, wherein
component (A) is at least one member selected from the group consisting of H₂N(CH₂)₃Si(OCH₃)₃, H₂N(CH₂)₃Si(OC₂H₅)₃, H₂N(CH₂)₂NH(CH₂)₃Si(OCH₃)₃, H₂N(CH2)₂NH(CH₂)₂NH(CH2)₃Si(OCH3)₃, and 3-(N-alkylamino)propyltrialkoxoxysilane, wherein alkyl is methyl, ethyl, n-propyl or n-butyl and alkoxy is methoxy or ethoxy;
component (B) is at least one member selected from the group consisting of (H₃CO)₃Si(CH₂)₃NH(CH₂)₃Si(OCH₃)₃, (H₅C₂O)₃Si(CH₂)₃NH(CH₂)₃Si(OC₂H₅)₃, (H₃CO)₃Si(CH₂)₃NH(CH₂)₂NH(CH₂)₂NH(CH₂)₃Si(OCH₃)₃, and (H₃CO)₃Si(CH₂)₃NH(CH₂)₂NH(CH₂)₂NH(CH₂)₂NH(CH₂)₂NH(CH₂)₃Si(OCH₃)₃; and
component (C) is at least one member selected from the group consisting of N[(CH₂)₃Si(OCH₃)₃]₃ and N[CH₂)₃Si(OC₂H₅)₃]₃.

31. The composition according to claim 15, wherein component (A) is 3-(N-alkylamino)propyltrialkoxysilane, wherein alkyl is n-butyl and alkoxy is methoxy.

32. The process according to claim 16, wherein
component (A) is at least one member selected from the group consisting of H₂N(CH₂)₃Si(OCH₃)₃, H₂N(CH₂)₃Si(OC₂H₅)₃, H₂N(CH₂)₂NH(CH₂)₃Si(OCH₃)₃, H₂N(CH2)₂NH(CH₂)₂NH(CH2)₃Si(OCH3)₃, and 3-(N-alkylamino)propyltrialkoxysilane, wherein alkyl is methyl, ethyl, n-propyl or n-butyl and alkoxy is methoxy or ethoxy;
component (B) is at least one member selected from the group consisting of (H₃CO)₃Si(CH₂)₃NH(CH₂)₃Si(OCH₃)₃, (H₅C₂O)₃Si(CH₂)₃NH(CH₂)₃Si(OC₂H₅)₃, (H₃CO)₃Si(CH₂)₃NH(CH₂)₂NH(CH₂)₂NH(CH₂)₃Si(OCH₃)₃, and (H₃CO)₃Si(CH₂)₃NH(CH₂)₂NH(CH₂)₂NH(CH₂)₂NH(CH₂)₂NH(CH₂)₃Si(OCH₃)₃; and
component (C) is at least one member selected from the group consisting of N[(CH₂)₃Si(OCH₃)₃]₃ and N[CH₂)₃Si(OC₂H₅)₃]₃.

33. The process according to claim 16, wherein component (A) is 3-(N-alkylamino)propyltrialkoxysilane, wherein alkyl is n-butyl and alkoxy is methoxy.
